(19) United States
(12) Patent Application Publication
(10) Pub. No.: US 2001/0032534 A1
(43) Pub. Date: Oct. 25, 2001

(54) TABLE SAW WITH SWITCHED RELUCTANCE MOTOR

(76) Inventors: WARREN A. CEROLL, OWING MILLS, MD (US); FREDERICK R. BEAN, FINKSBURG, MD (US); MARIA I. KENYON, TANEYTOWN, MD (US); JAMES R. PARKS, TIMONIUM, MD (US); ROBERT S. GEHRET, HAMPSTEAD, MD (US); DAVID A. PORTER, HANOVER, PA (US); MICHAEL L. O'BANION, WESTMINISTER, MD (US); DANIEL PUZIO, BALTIMORE, MD (US); KEVIN D. BREWER, MOUNT JOY, PA (US)

Correspondence Address: ADAM AYALA, THE BLACK & DECKER CORPORATION, 701 EAST JOPPA ROAD-TW199, TOWSON, MD, 21286

(21) Appl. No.: 09/034,746

(22) Filed: Mar. 4, 1998

Related U.S. Application Data
(63) Continuation-in-part of application No. 08/663,538, filed on Jun. 17, 1996, now Pat. No. 5,875,698.
(60) Provisional application No. 60/044,459, filed on Apr. 29, 1997.
(60) Provisional application No. 60/058,521, filed on Sep. 11, 1997.

(51) Int. Cl. B27B 5/24

(52) U.S. Cl. 83/473; 83/477.1; 83/481; 83/491

(57) ABSTRACT

A machine tool has a work table which defines a working surface and has a cutting tool which is attached to and movable with respect to the work table. The position of the cutting tool with respect to the working surface is controlled by a mechanism which elevates the cutting tool with respect to the working surface and angulates the cutting tool with respect to the working surface. The cutting tool is mounted to a support plate which is pivotably attached to the work table. The elevating mechanism includes a threaded rod and a nut which engages a pivoting link. The pivoting link also engages the cutting tool. Rotation of the threaded rod pivots the link which in turn raises and lowers the cutting tool. A spring biases the cutting tool towards its lower position to remove play between the components. The angulating mechanism includes a lever, two cams and a locking rod. Rotation of the lever moves the locking rod longitudinally due to the action between the two cams. The longitudinal movement of the rod compresses the support plate between the work table and a bracket to maintain the position of the support plate with respect to the work table. Also included is an integral arbor wrench which is accessible when the throat plate is removed to lock the arbor to facilitate tool changing. The wrench is designed to not allow reassembling of the throat plate when the wrench is in engagement with the arbor shaft.

### CROSS-REFERENCE TO RELATED APPLICATIONS

The present application is based upon and claims priority under 35 USC § 119 and 37 CFR § 1.78 of copending U.S. provisional applications Ser. No. 60/044,459, filed on Apr. 29, 1997, and Ser. No. 60/058,521, filed on Sep. 11, 1997. The present application is also a continuation-in-part of U.S. application Ser. No. 08/663,538, filed on Jun. 17, 1996.

### BACKGROUND OF THE INVENTION

The present invention relates to a table saw with a switched reluctance motor, and more particularly, to a table saw with a switched reluctance motor having a variable speed and automatic braking for operating a rotatably mounted saw blade.

Most prior art table saws use universal motors and gear or belt reduction drives to power a rotatably mounted saw blade. For turning the universal motor on and off in a convenient manner, a switch is utilized. Recent models of prior art table saws may also employ a brake to shorten the coast downtime of a rotatably mounted saw blade. This is accomplished by reconnecting the universal motor into a short circuited generator. This is sometimes referred to as “regenerative” braking or “dynamic” braking. A separate circuit operated by a second contact of the switch engages and disengages the brake. Unfortunately, the optimum brush timing, or “brush lead,” is different for a motor and a generator. Thus, braking the motor in the manner described above increases wear and tear on the motor brush and commutator. In addition, the braking action of a universal motor decreases sharply as the motor slows down, increasing the total stopping time.

As will be seen in the discussion that follows, the present invention employs a switched reluctance motor which eliminates the aforementioned problems associated with universal motors, particularly those that employ regenerative or dynamic braking.

### SUMMARY OF THE INVENTION

The object of the present invention is achieved by providing a table saw having a table, a frame supporting that table, a rotatably mounted saw blade mounted under the table, a switched reluctance motor to said saw blade for rotatable powered operation thereof about its rotatable mounting, and drive circuit for controlling the operation of the switched reluctance motor.

Other aspects and advantages of the invention will become apparent from the description and claims which follow.

### BRIEF DESCRIPTION OF THE DRAWINGS

The accompanying drawings illustrate preferred embodiments of the invention according to the practical application of the principles thereof, and in which:

FIG. 1 is a perspective view of a table saw in accordance with the present invention;

FIG. 2 is a cutaway perspective view of the table saw shown in FIG. 1;

FIG. 3 is a cut-away perspective view similar to FIG. 2 with the motor, saw blade and gear case removed to illustrate the angular adjustment mechanism;

FIG. 4 is an exploded perspective view of the angular adjustment mechanism shown in FIG. 3;

FIG. 5 is a side view of the support plate shown in FIGS. 1-3 with the motor, saw blade and mounting plate included to illustrate the height adjustment mechanism;

FIG. 6 is an end view of the height adjustment mechanism shown in FIG. 5;

FIG. 7 is an exploded perspective view of the pivot quadrants incorporated into the angular adjustment mechanism;

FIG. 8 is a schematic cross-sectional view taken through the gear case illustrating the assembly of the gear case to the support plate;

FIG. 9 is an exploded perspective view of the height adjustment mechanism shown in FIGS. 5-6;

FIG. 10 is a side view illustrating the arbor locking mechanism in the unlocked position;

FIG. 11 is a side view similar to FIG. 10 but showing the locking mechanism in the locked position;

FIG. 12 is a side view schematically illustrating an adjustment mechanism for the bevel adjustment system; and

FIG. 13 is a block diagram of a control circuit for operating a switched reluctance motor that drives the rotatably mounted saw blade.

### DETAILED DESCRIPTION

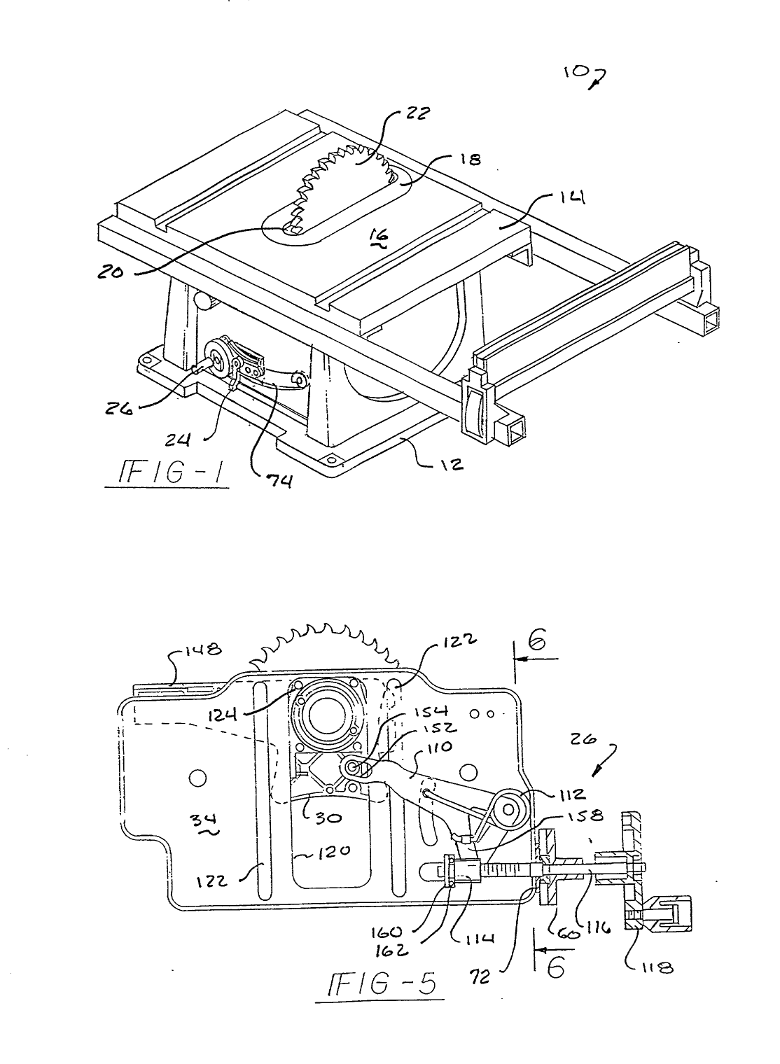

Referring now to the drawings in which like reference numerals designate like or corresponding parts throughout the several views, there is shown in FIG. 1 a table saw which is designated generally by the reference numeral 10 incorporating a switched reluctance motor in accordance with the present invention. Table saw 10 comprises a base 12 which supports a generally rectangular work table 14 defining a working surface 16. Work table 14 includes a throat plate 18 which includes an elongated slot 23 through which a circular saw blade 22 protrudes. Saw blade 22 is capable to being adjusted for angularity with respect to working surface 16 by an angular bevel adjustment mechanism 24 as well as being capable for being adjusted for depth of cut by a height adjustment mechanism 26.

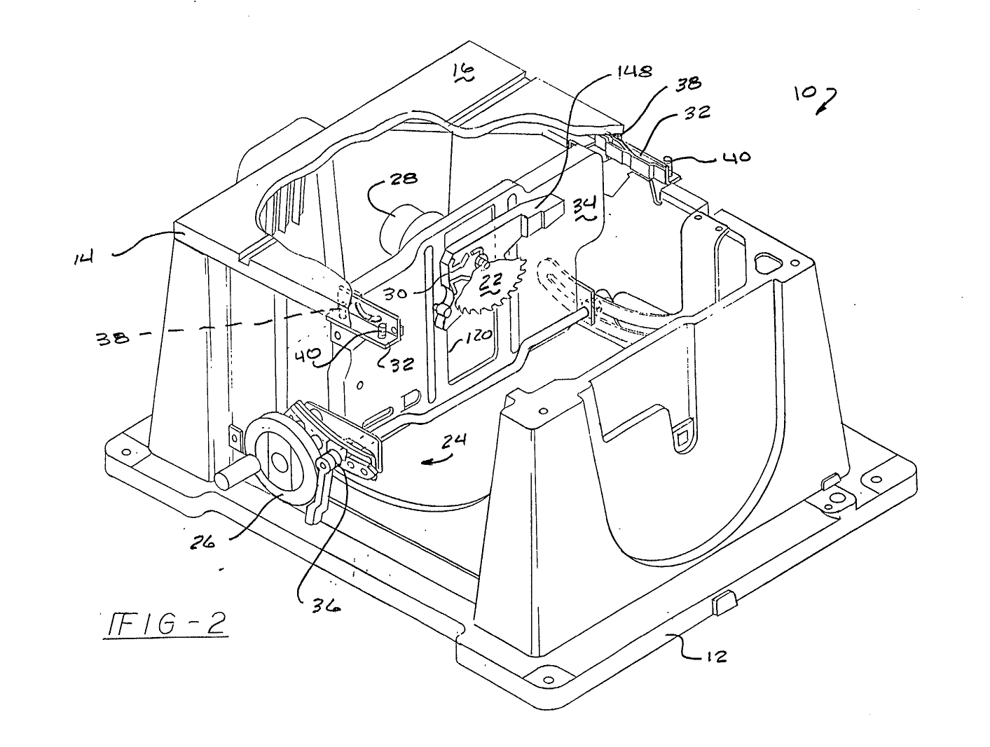

Referring now to FIG. 2, table saw 10 is illustrated with working surface 16 of work table 14 partially removed and a portion of base 12 cutaway. Circular saw blade 22 is rotated by a motor 28 which power saw blade 22 through a gear case 30. Bevel adjustment mechanism 24 adjusts the angular position of saw blade 22 by pivoting saw blade 22, motor 28 and gear case 30. Height adjustment mechanism 26 adjusts the cutting depth of saw blade 22 by longitudinal movement of saw blade 22, motor 28 and gear case 30. Persons skilled in the art will recognize that other means for adjusting the height and the bevel of the blade assembly can be achieved using different means. As discussed above, the motor 28 has typically been a universal motor that is connected to a belt or gear reduction drive for driving the rotatably mounted saw blade 22. The present invention employs a switched reluctance motor as the motor 28 in the table saw 10.

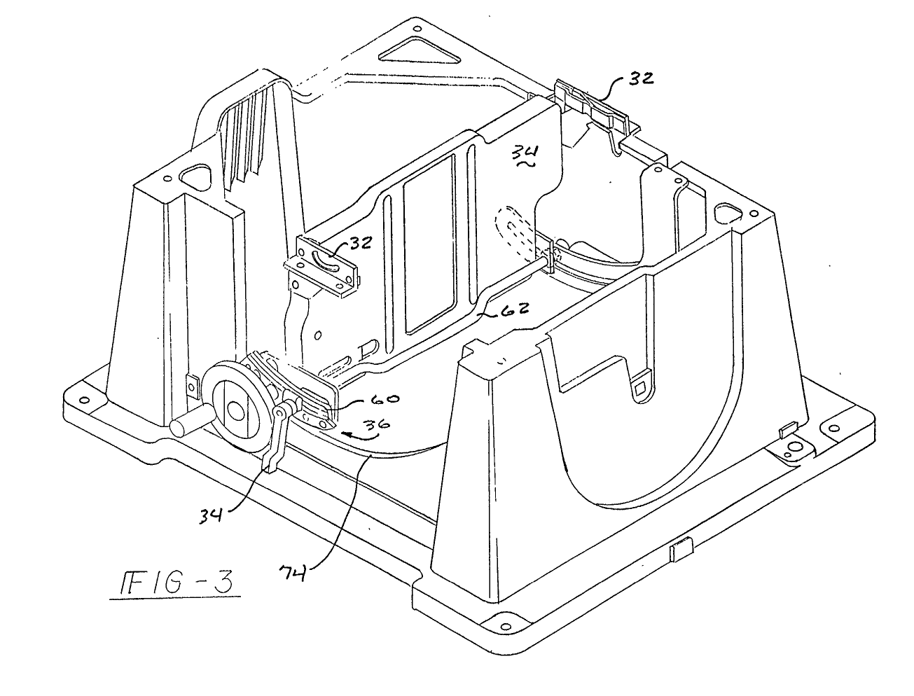

Referring now to FIGS. 2 and 3, bevel adjustment mechanism 24 comprises a pair of pivot quadrants 32, a support plate 34, and a locking system 36. Each pivot quadrant 32 is attached to a plurality of bosses 38 extending from the bottom of work table 14 using a plurality of bolts 40. Each pivot quadrant 32 is designed to pivot around a center which is located on working surface 16 of work table 14 coincident with the plane of saw blade 22. Thus, the axis for pivoting support plate 34 lies on working surface 16 and extends through the plane of saw blade 22 when saw blade 22 is generally perpendicular with working surface 16. As shown in FIG. 7, pivot quadrant 32 is comprised of a support bracket 42, a pivot bracket 44 and a retaining strap 46. Support bracket 42 is an L-shaped bracket which defines a plurality of holes 48 to facilitate the attachment of pivot quadrant 32 to work table 14 on one leg of the L. The opposite leg of the L defines an arcuate slot 50 which controls the pivotal movement of pivot bracket 44 and locates the center of the pivoting at working surface 16 of work table 14. Pivot bracket 44 extends between support bracket 42 and support plate 34 and defines a plurality of holes 52 at one end to facilitate the attachment of support plate 34. The opposite end of pivot bracket 44 defines a stamped arcuate protrusion 54 which mates with slot 50 to control the pivoting of pivot bracket 44. Protrusion 54 is formed out of the material of pivot bracket 44 and this forming operation defines an arcuate slot 56 once protrusion 54 has been formed. Retaining strap 46 extends across pivot bracket 44 and is attached to support bracket 42 to maintain the engagement of protrusion 54 with slot 50. Retaining strap 46 defines a formed protrusion 58 which extends into slot 56 to both guide the pivotal movement of pivot bracket 44 and to act as a stop to limit the pivotal movement of pivot bracket 44.

Referring now to FIGS. 3 and 4, support plate 34 is a shallow drawn plate which is attached to pivot quadrants 32. Support plate 34 is designed to support both height adjustment mechanism 26 and locking system 36. Locking system 36 comprises a bearing block 60, a locking rod 62, a locking arm 64, a bearing block cam 66, a locking arm cam 68 and a return spring 70. Bearing block 60 is a curved member which is attached to a bracket 72 which is in turn attached to support plate 34. Bearing block 60 thus pivots with support plate 34 and bearing block 60 extends through an arcuate slot 74 in the front face of base 12. While the pivotal movement of support plate 34 moves bearing block 60 within slot 74, it should be understood that the movement of support plate 34 is controlled by pivot quadrants 32 and that a clearance will always exist between bearing block 60 and slot 74.

Locking rod 62 extends across support plate 34 and through bracket 72 and bearing block 60 in the front of support plate 34 and through a bracket 76 and a bracket 78 located at the rear of support plate 34. Bracket 76 is attached to support plate 34 and defines an aperture for accepting and guiding locking rod 62. Bracket 78 is attached to work table 14 and it defines an arcuate slot 80 which accepts locking rod 62 and allows for the pivotal movement of support plate 34. While the pivotal movement of support plate 34 moves locking rod 62 within slot 80, it should be understood that the movement of support plate 34 is controlled by pivot quadrants 32 and that a clearance will always exist between locking rod 62 and slot 80. Once locking rod 62 has been inserted through brackets 76 and 78, a washer 82 and a nut 84 are assembled to locking rod 62 to provide adjustment for locking system 34. The front end of locking rod 62 extends through bearing block 60 and through a D-shaped embossment 86 which is an integral part of bearing block 60. Locking arm 64 is assembled over the end of locking rod 62 and secured to locking rod 62 using a hardened washer 88, a thrust bearing 90, a hardened washer 92 and a nut 94 threadingly received on locking rod 62 as shown in FIG. 4.

Bearing block cam 66 and locking arm cam 68 are disposed between locking arm 64 and bearing block 60. D-shaped embossment 86 extends from bearing block 60 through slot 74 in the front face of base 12. Bearing block cam 66 includes a D-shaped aperture which mates with embossment 86 and cam 66 is positioned such that the front face of base 12 is sandwiched between bearing block 60 and bearing block cam 66. The engagement of the D-shaped aperture of cam 66 with D-shaped embossment 86 prohibits the rotational movement of cam 66 with respect to bearing block 60. The face of cam 66 opposite to the front surface of base 12 defines a camming surface 96 which reacts with locking arm cam 68 to activate locking system 34.

Locking arm 64 defines a D-shaped embossment 98 which mates with a D-shaped aperture extending through locking arm cam 68 such that locking arm cam 68 pivots with locking arm 64 when locking arm 64 pivots on locking rod 62. The face of cam 68 opposite to locking arm 64 defines a camming surface 100 which mates with camming surface 96 on cam 66 such that pivoting motion of locking arm 64 with respect to locking rod 62 will cause longitudinal movement of locking rod 62 to activate locking system 36. Return spring 70 is disposed on locking rod 62 between an ear 102 formed on locking rod 62 and bearing block 60 in order to urge locking rod 62 towards the rear of base 12 or towards bracket 78. Locking rod 62 is shown with an additional ear 102 on the opposite side of return spring 70 to capture spring 70 in the unassembled condition of locking rod 62. The additional ear 102 requires that the aperture in bearing block 60 which accepts locking rod 62 be provided with a slot (not shown) to accept the additional ear 102. In this arrangement, the engagement of the additional ear 102 with the slot in bearing block 60 will prohibit any rotational movement of locking rod 62.

When camming surface 96 is aligned with camming surface 100, pivoting of support plate 34 and thus saw blade 22 and motor 28 is permitted. The biasing of locking rod 62 towards the rear of base 12 causes embossment 98 to bottom against embossment 86. In this condition, there is a clearance created between camming surface 96 and camming surface 100 as well as a clearance created between bracket 76 and bracket 78. These clearances allow for a smooth pivoting of support plate 34 and thus a smooth angular adjustment for saw blade 22. The pivoting of support plate 34 is controlled by pivot quadrants 32 while bearing block 60 moves within slot 74 in the front face of base 12 and locking rod 62 moves within slot 80 in bracket 78. When the desired angle of saw blade 22 is obtained, locking system 36 is activated by pivoting locking arm 64 on locking rod 62 which rotates cam 68 with respect to cam 66. Camming surface 100 is cammed away from camming surface 96 causing longitudinal movement of locking rod 62. The longitudinal movement of locking rod 62 compresses support plate 34 between bracket 78 and the front face of base 12 due to washer 82 and nut 84 engaging bracket 78 and bearing block cam 66 engaging the front surface of base 12. The flexibility of locking rod 62 due to a center off-set area 104 and the flexibility of bracket 78 permit the compression of support plate 34. The adjustment for locking system 36 is provided for by nut 84.

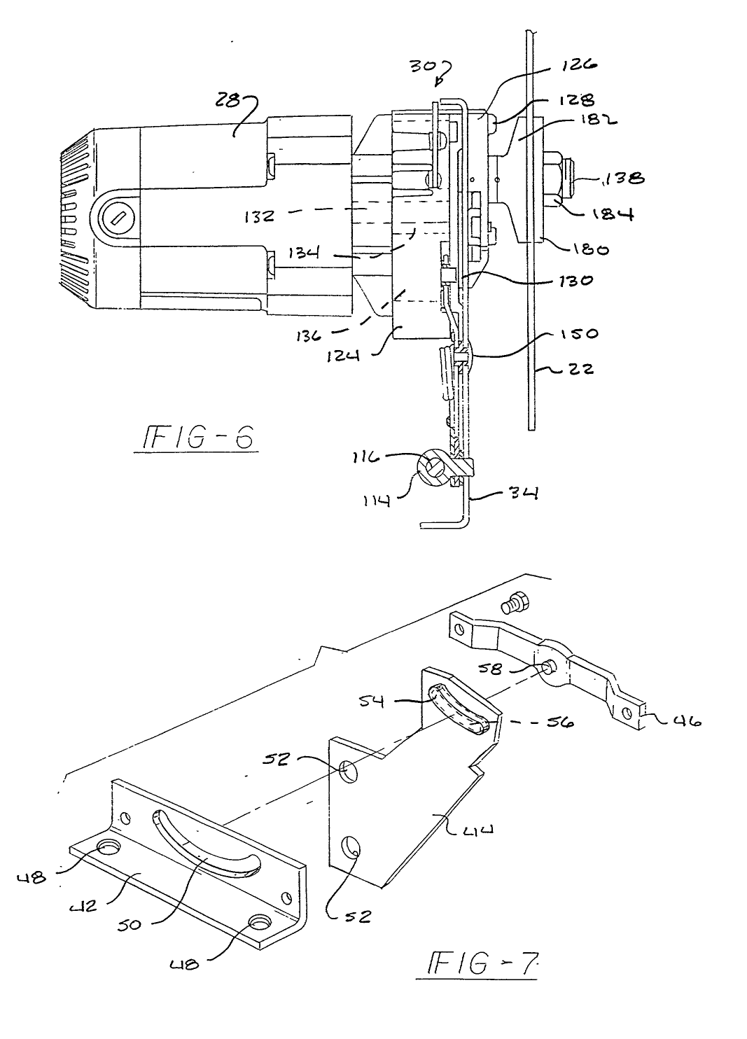

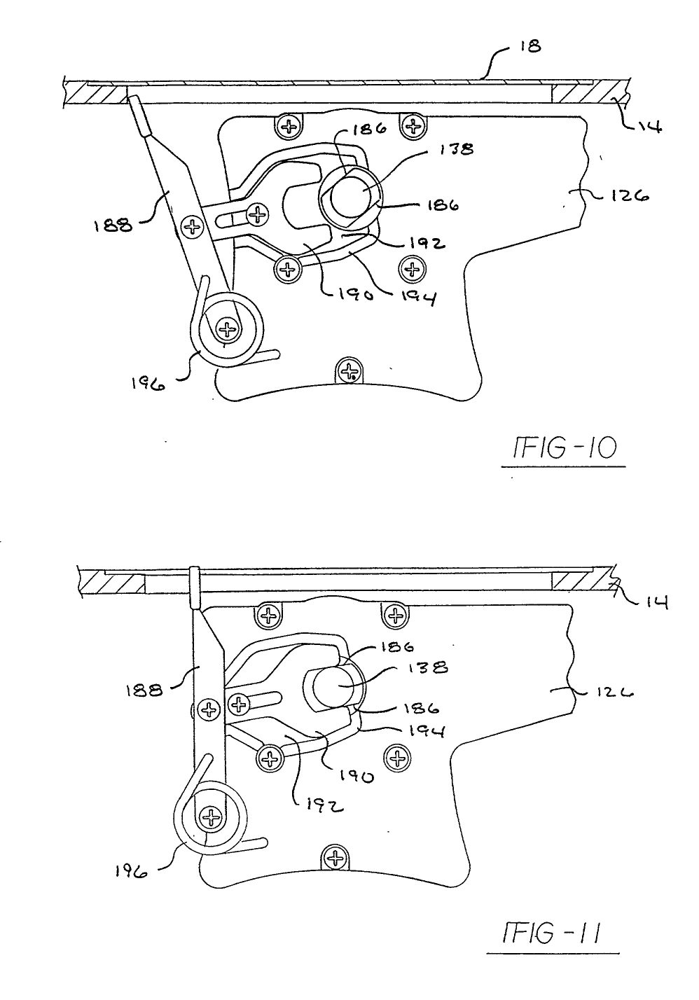

Referring now to FIGS. 2, 5, 6 and 9, height adjustment mechanism 26 comprises a pivot link 110, a biasing spring 112, a follower nut 114, a height adjustment screw 116 and a crank handle 118 which function to move saw blade 22, motor 28 and gear case 30 longitudinally with respect to support plate 34.

Support plate 34 defines a generally rectangular opening 120 within which gear case 30 is located. Located adjacent to and extending generally the entire length of opening 120 are a pair of formed ribs 122 which provide stiffness to support plate 34. Gear case 30 includes a housing 124 disposed on one side of support plate 34 and a cover 126 disposed on the opposite side of support plate 34. Cover 126 is secured to housing 124 by a plurality of bolts 128 such that support plate 34 is sandwiched between cover 126 and housing 124. Gear case 30 includes a pair of longitudinally extending surfaces 130 which engage the opposing sides of opening 120 to guide the movement of gear case 30 within opening 120. Motor 28 is attached to housing 124 and includes an armature shaft 132 having a pinion 134 which meshes with an output gear 136 which is rotatably supported within gear case 30. The output gear includes an arbor shaft 138 which provides for the attachment of saw blade 22. Thus, when motor 28 is powered, armature shaft 132 and pinion 134 rotate which rotates output gear 136 and arbor shaft 138 which in turn rotates saw blade 22.

In the prior art, single thread screws have been used for the arbor shaft 138. However, because of the repeated high loads applied to the blade 22 when cutting, the arbor nut 184 and washers 180 and 182 may be dragged rotationally in a self-tightening direction. This could make removal of the arbor nut 184 difficult. A prior art solution includes using a double “D” to lock washer 180 or washer 182 to the arbor shaft 138 to prevent dragging, and self-tightening, of the arbor nut 184. This solution requires additional hardware parts or additional machining operations, thus raising manufacturing costs.

Accordingly, it is preferable that the arbor shaft 138 have a twin lead thread, or double thread. As such, the angle of the threads relative to a plane perpendicular to the shaft axis, or alpha angle, in the double thread shaft is larger than the alpha angle in the single thread shaft. The larger alpha angle helps reduce the torque applied on the arbor nut 184, diminishing its self-tightening. For example, if the double thread shaft's alpha angle is twice that of a single thread shaft's alpha angle, the torque applied on the double-threaded arbor nut would be about half of the torque applied on the single-threaded arbor nut. Such reduction of torque minimizes the arbor nut's self-tightening. Persons skilled in the art will recognize that this result can also be achieved so long as multiple threads, i.e., triple, quadrupule, etc., threads, are used on the arbor shaft.

The alpha angle should be at least 3° and preferably in a range between 5° and 5.4°. Such range provides a small screw pitch that prevents a thin blade from falling into the space between the threads. Otherwise, the blade would fall into the space between the threads, making the blade eccentric relative to the shaft, causing excess vibration and poor cut characteristics, especially at the normal operating speeds of about 4000 RPM.

The increased alpha angle solution is also advantageous as it can be implemented with any kind of thread shape. In other words, the thread cross-sectional shape can be triangular (V-shaped), round (arcuate), trapezoidal, square, etc. Preferably, the thread used in the arbor shaft 138 substantially square and is commonly known as the “ACME thread”.

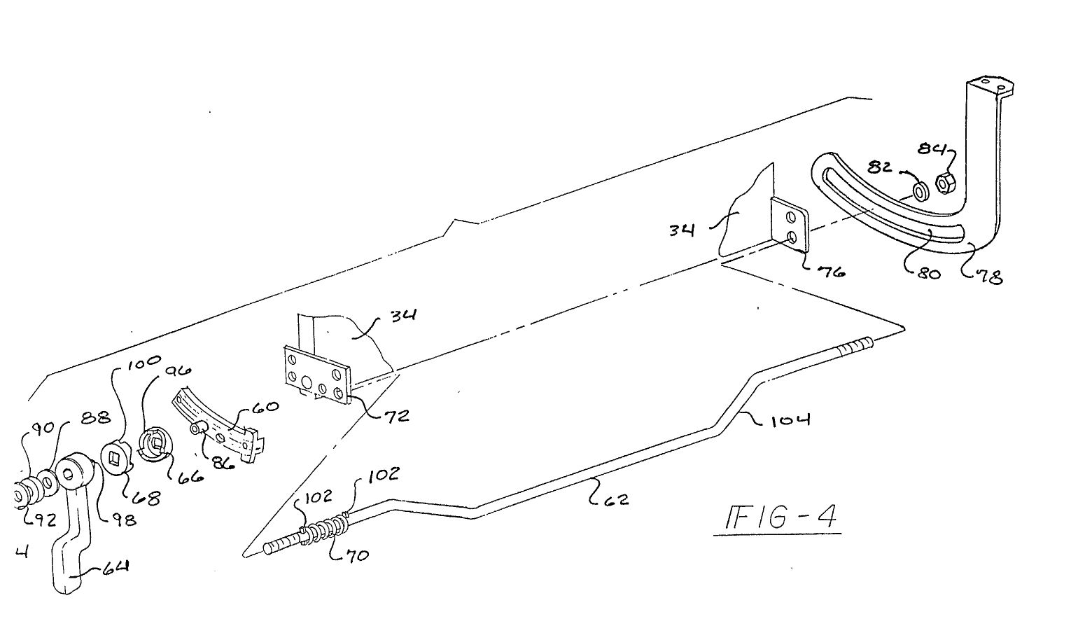

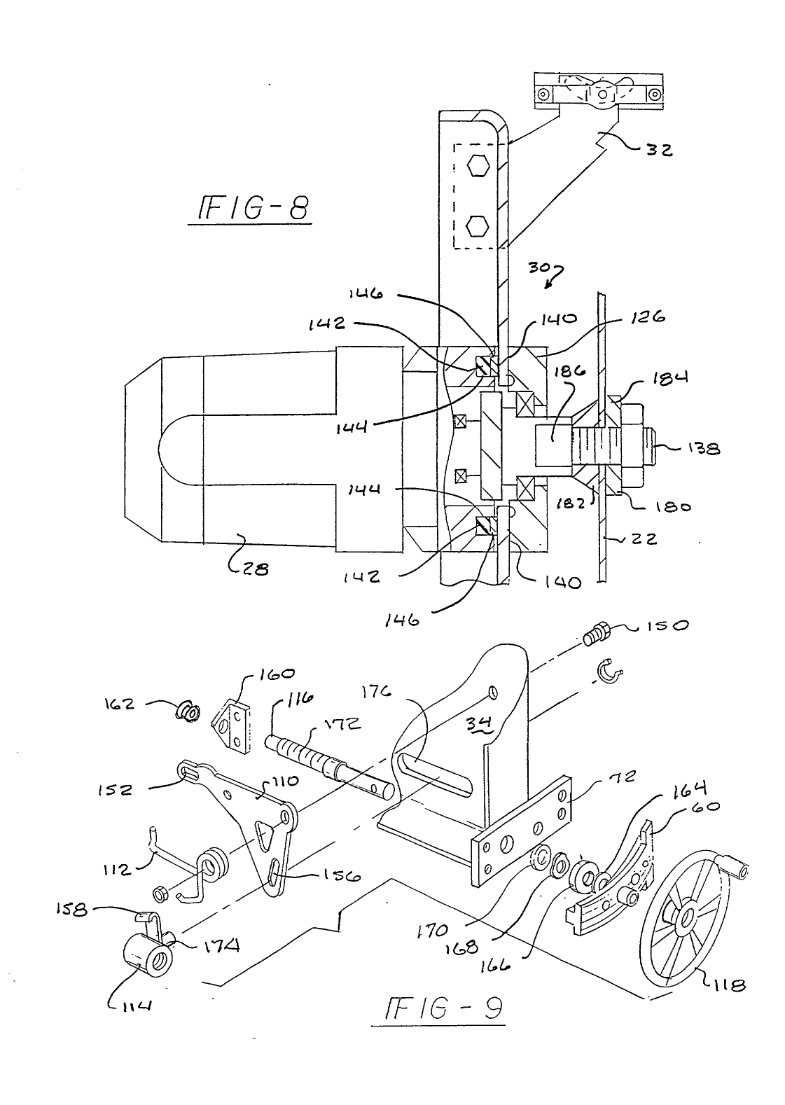

Referring now to FIG. 8, the accurate positioning of saw blade 22 is required in order to provide accurate cuts. In order to accurately position saw blade 22, the front face, or the face adjacent saw blade 22, of support plate 34 is defined as a datum face. Cover 126 is provided with a plurality of accurately machines pads 140 which accurately position cover 126 and thus saw blade 22 with respect to support plate 34. Machine pads 140 are biased against the datum face on support plate 34 by a plurality of elastomeric springs 142 each of which is disposed within an aperture 144 defined by housing 124. A low friction wear pad 146 is disposed between each elastomeric spring 142 and support plate 34 to facilitate the movement of gear case 30 within opening 120. Thus, gear case 30, motor 28 and saw blade 22 move longitudinally within opening 120 guided by surfaces 130 with gear case 30 being biased against the datum face of support plate 34 by elastomeric springs 142. As shown in FIGS. 2 and 5, cover 126 includes an extension 148 which can be utilized for supporting a splitter and/or guard mechanism for table saw 10 if desired The mounting of the splitter and/or guard mechanism on cover 126 allows the components to travel with saw blade 22 during cutting depth and/or angular adjustments.

Referring back to FIGS. 2,5,6 and 9, pivot link 110 is pivotably secured to support plate 34 by an appropriate fastener 150. One arm of pivot link 110 defines a slot 152 which engages a pin 154 attached to gear case 30. The second arm of pivot link 110 defines a slot 156 which engages follower nut 114. Biasing spring 112 is a tension spring positioned around fastener 150 and is disposed between pivot link 110 and a retainer 158. Retainer 158 is attached to follower nut 114 and biasing spring 112 is positioned such that its spring force biases gear case 30 towards a downward position. By biasing pivot link 110 in this direction, the play between the various components of height adjustment mechanism 26 can be eliminated. In addition, the biasing load provided by biasing spring 112 is resisted by follower nut 114 and not by adjustment screw 116 as in many prior art table saws.

Height adjustment screw 116 is rotatably secured at one end by a bracket 160 which is a separate component or bracket 160 can be formed out of support plate 34. A nylon bushing 162 is disposed between screw 116 and bracket 160 to facilitate the rotation of screw 116 and provide a smoothness of operation. The loading and thus the wear between screw 116, bushing 162 and bracket 160 is significantly reduced due to the reaction of spring 112 occurring through follower nut 114 and not through screw 116. The opposite end of adjustment screw 116 extends through and is rotatably supported by bearing block 60. The portion of adjustment screw 116 which extends beyond bearing block 60 is adapted for securing crank handle 118 to adjustment screw 116 such that rotation of crank handle 118 causes rotation of adjustment screw 116. Disposed between bearing block 60 and bracket 72 of support plate 34 is a hardened washer 164, a powdered metal washer 166, a spring thrust washer 168 and a hardened washer 170. Powdered metal washer 166 is secured to adjustment screw 116 by press fitting or other means known in the art. The biasing of spring thrust washer 168 produces frictional resistance to the rotation of adjustment screw 116 allowing for the accurate positioning of saw blade 22 and the ability of height adjustment mechanism 26 to maintain the position of saw blade 22 during the cutting operation. The frictional resistance or drag produced by spring thrust washer 168 maintains the position of adjustment screw 116 and is not affected by the vibration produced by motor 28 and/or the cutting operation. In addition, the biasing produced by spring thrust washer 168 removes any play which may exist between the various components of height adjustment 26.

Follower nut 114 is threadingly received on a threaded portion 172 of screw 116 which is located between bracket 160 and bearing block 60. Follower nut 114 includes a cylindrical finger 174 which extends into retainer 158, into slot 156 of pivot link 110 and into a slot 176 located in support plate 34 to cause the pivoting of pivot link 110 by follower nut 114. Slot 176 in support plate 34 prohibits rotation of follower nut 114 and tends to guide follower nut 114 as it moves along screw 116. In addition, the contact between finger 174 and the edge of slot 176 provides the reaction point for spring 112. Thus, when crank handle 118 is rotated, adjustment screw 116 is rotated which causes follower nut 114 to move longitudinally along threaded portion 172 of adjustment screw 116. The direction of movement of follower nut 114 will be determined by the design of threaded portion 172 and the direction of rotation of crank handle 118. The longitudinal movement of follower nut 114 causes pivotal movement of pivot link 110 due to the engagement of finger 174 which engages slot 156. The pivotal movement of pivot link 110 causes the longitudinal movement of gear case 30, motor 28 and saw blade 22 due to the engagement of slot 152 with pin 154. The longitudinal movement of gear case 30, motor 28 and saw blade 22 sets the height of saw blade 22 extending through work table 14 and thus the depth of cut.

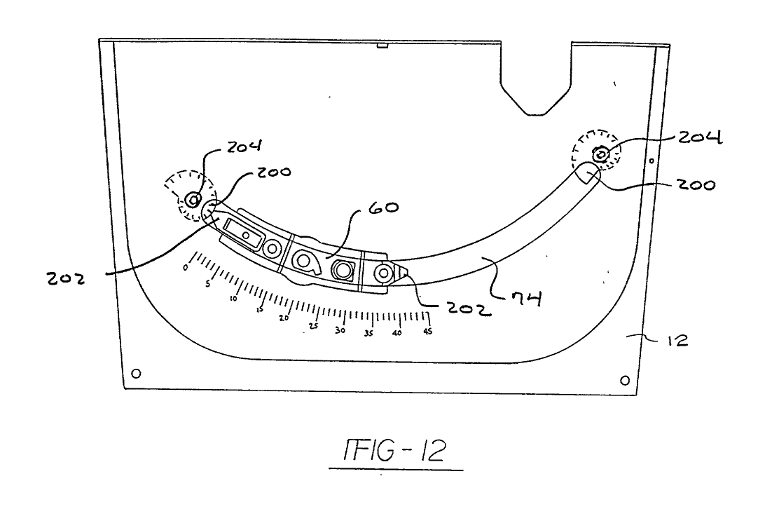

Referring to FIGS. 8, 10 and 11, cover 126 of gear case 30 supports another unique feature for machine tool 10. One of the problems associated with machine tools is the changing of the cutting tool. Saw blade 22 is assembled to arbor shaft 138 and is frictionally held in position by a pair of washers 180, 182 and an arbor nut 184. Arbor shaft 138 includes a pair of flats 186 which accept a wrench (not shown) in order to stop arbor shaft 138 from rotating when arbor nut 184 is to be loosened or tightened during the changing of saw blade 22. The wrench for engaging flats 186 is normally a separate piece which is easily misplaced which then leads to the wedging of a block of wood or other material against saw blade 22 to hold arbor shaft 138. The wedging of the block against saw blade 22 is both dangerous and leads to unnecessary loading of the bearings supporting arbor shaft 138. The present invention includes a lever 188 which is pivotably secured to cover 126. A wrench 190 is pivotably secured to lever 188 and moves within a pocket 192 formed by a ridge 194 which is an integral part of cover 126 between an unlocked position shown in FIG. 10 and a locked position shown in FIG. 11. A spring 196 biases wrench 190 into its unlocked position.

The unlocked position of wrench 190 is shown in FIG. 10 where wrench 190 is disconnected from flats 186 and arbor shaft 138 is free to rotate. The locked position is shown in FIG. 11 where wrench 190 engages flats 186 to prohibit rotation of arbor shaft 138. The end of wrench 190 engages ridge 194 at both the front of wrench 190 adjacent arbor shaft 138 to provide support for wrench 190 in the locked position and at the rear of wrench 190 adjacent to lever 188 to provide support to counteract the torque being allied to arbor nut 184. Lever 188 is accessible to the operator of table saw 10 through the opening in work table 14 which accepts throat plate 18. Lever 188 is designed to extend into the throat plate opening of work table 14 when wrench 190 is in the locked position and saw blade 22 is in its full upward position as shown in FIG. 11 to prohibit the assembly of throat plate 18 with work table 14 while wrench 190 is in the locked position. Once wrench 190 is moved to its unlocked position, lever 188 will be removed from the throat plate opening in work table 14 and throat plate 18 can be assembled to work table 14.

FIG. 12 illustrates a bevel angle stop system for bevel adjustment mechanism 24. An adjustment cam 200 is attached to the front panel of work table 14 at opposite ends of slot 74. A protrusion 202 is formed at both ends of bearing block 60. When saw blade 22 is positioned at a point perpendicular to working surface 16, adjustment cam 200 at the zero degree position is rotated until it contacts the zero degree protrusion 202 on bearing block 60. Adjustment cam 200 is tightened in position using a bolt 204 to set the zero degree position of saw blade 22. The tightening of bolt 204 has a tendency to rotate cam 200 in a clockwise direction. The rotation of cam 200 in a clockwise direction urges cam 200 into contact with protrusion 202 due to the external spiral shape of cam 200 to provide an accurate positioning of the bevel angle for saw blade 22. The perpendicularity of saw blade 22 can be set by a square or other means known well in the art. In a similar manner, the 45° position of saw blade 22 with respect to working surface 16 can be set by a similar adjustment and locking of adjustment cam 200 located on the opposite side of slot 74.

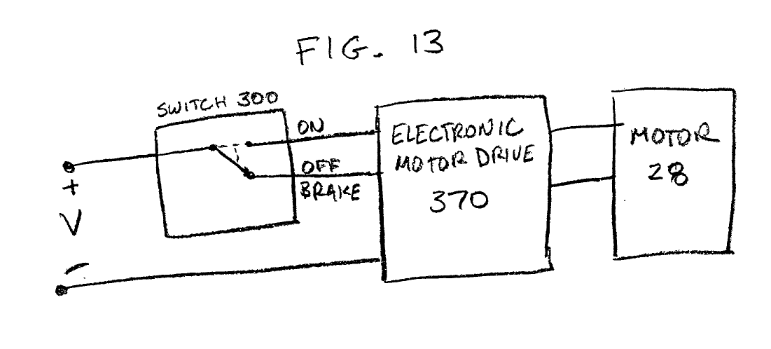

As shown in FIG. 13, a schematic control circuit is illustrated showing the switched reluctance motor 28 electrically connected to the electronic motor drive 29 and operated by the switch 300 in the base 12 of the table saw 10. Switched reluctance motors rely upon semiconductor switches and complex logic for operation. Such motors are also capable of braking, again relying upon those same semiconductor switches and logic.

As in prior art table saws, the switch 300 may include first and second contacts. Thus, upon depression of the switch 300, the switched reluctance motor 28 is energized to drive the rotatably mounted saw blade 22. Upon release of the switch 300, the second contact can be electrically connected to the electronic motor drive 370 to brake the switched reluctance motor 28. This will be similar to the present practice. However, unlike the universal motors, switched reluctance motors can be controlled to provide braking down to near zero speed, thus reducing total stopping time.

Alternatively, the electronic motor drive 370 can be configured to sense that the switch 300 is open, in other words, released, and then automatically brake the switched reluctance motor 28. Thus, the electronic motor drive 370 can be configured in any desired manner to work in conjunction with the switch 30 to brake the switched reluctance motor 28.

Other variations are possible including the addition of a variable speed control to the switched reluctance motor 28. Another variation can include a soft start, i.e., relatively slow ramp up of motor speed, in the electronic motor drive 370 in order to reduce the strain on a gear reduction drive as well as reduce the starting in rush current to the switched reluctance motor 28. This is an advantage when long extension cords are used.

From the foregoing, it will now be appreciated that the table saw with switched reluctance motor eliminates wear and tear on brushes and commutators as in prior art universal motors as well as regenerative or dynamic braking associated with the universal motor. Wear and tear is substantially eliminated because switched reluctance motors rely upon semiconductor switches and complex logic to operate. Because switched reluctance motors are capable of braking, as a result of the semiconductor switches and logic, they can be controlled to provide braking down to near zero speed, thus reducing the total stopping time.

Persons skilled in the art may recognize all of the alternatives to the means disclosed herein. However, all these additions and/or alterations are considered to be equivalents of the present invention.

What is claimed is:

1. A machine tool comprising:
a work table defining a work surface;
a cutting tool attached to and movable with respect to said work table; and
a switched reluctance motor driving the cutting tool.

2. The machine tool of claim 1, further comprising:
a mechanism for positioning said cutting tool relative to said working surface of said work table, said mechanism comprising:
a support plate pivotably secured to said work table, said cutting tool being mounted to said support plate to move between a first position where said cutting tool extends through an aperture in said work table and a second position where said cutting tool is positioned below said working surface;
a cutting tool angulating mechanism mounted to said support plate, said angulating mechanism being operable to pivot said support plate with respect to said work table such that said cutting tool angulates with respect to said working surface; and
a cutting tool elevating mechanism mounted to said support plate, said elevating mechanism being operable to move said cutting tool between said first and said second positions.

3. The machine tool according to claim 2 wherein said support plate pivots about an axis which is located on said working surface.

4. The machine tool according to claim 2 further comprising at least one pivot quadrant for pivotably securing said support plate to said work table.

5. The machine tool according to claim 4 wherein said pivot quadrant comprises:
a support bracket attached to said work table;
a pivot bracket pivotably attached to said support bracket and fixably attached to said support plate; and
a retaining strap attached to said support bracket, said retaining strap engaging said pivot bracket to maintain attachment of said pivot bracket to said support bracket.

6. The machine tool according to claim 2 wherein said angulating mechanism comprises:
a locking rod extending between a front side and a rear side of said support plate;
a bracket attached to said work table and positioned adjacent to said rear side of said support plate, said locking rod extending through said bracket;
a locking arm attached to said locking rod and movable between a first position and a second position, said support plate being free to pivot relative to said work table when said locking arm is in said first position, said support plate being compressed between said bracket and said work table to prohibit pivoting of said support plate when said locking arm is in said second position.

7. The machine tool according to claim 6 further comprising a bearing block cam attached to said support plate and a locking arm cam attached to said locking arm, said locking arm cam cooperating with said bearing block cam when said locking arm is moved from said first position to said second position to compress said support plate.

8. The machine tool according to claim 7 further comprising a biasing member disposed between said support plate and said locking arm, said biasing member urging said locking arm in a direction which urges said locking arm into contact with said support plate to create a clearance between said bearing block cam and said locking arm cam and to create a clearance between said bracket and said support plate.

9. The machine tool according to claim 6 wherein, said work table includes at least one adjustable stop, said adjustable stop including a cam rotatably secured to said work table, said cam being selectively locked to said work table in a plurality of positions to adjustably limit thee pivoting of said support plate.

10. The machine tool according to claim 2 wherein said elevating mechanism comprises:
an adjustment screw rotatably secured to said support plate;
an adjustment nut threadably engaging said adjustment screw such that rotation of said adjustment screw operates to move said adjustment nut longitudinally along said adjustment screw; and
a pivot link pivotably secured to said support plate, said pivot link extending between said adjustment nut and said cutting tool such that rotation of said adjustment screw operates to pivot said pivot link to move said cutting tool between said first and said second positions.

11. The machine tool according to claim 10 further comprising a biasing member for urging said cutting tool into one of said first and second positions.

12. The machine tool according to claim 10 further comprising means for resisting rotation of said adjustment screw.

13. The machine tool according to claim 12 wherein, said means for resisting comprises a washer attached to said adjustment screw and a biasing member for urging said washer against said support plate to provide frictional resistance to rotation of said adjustment screw.

14. The machine tool according to claim 2 wherein, said cutting tool comprises:
a gear case mounted to said support plate;
a motor attached to one end of said gear case;
an arbor shaft rotatably secured to a second end of said gear case; and
a cutting device attached to said arbor shaft.

15. The machine tool according to claim 14 wherein, said gear case is biased against a face of said support plate.

16. The machine tool according to claim 14 further comprising:
a lever pivotably attached to said gear case and movable between a first position and a second position;
a wrench pivotably attached to said lever, said wrench adapted to engage said arbor shaft to prevent its rotation with respect to said gear case when said lever is in said first position, said arbor shaft being free to rotate when said lever is in said second position.

17. The machine tool according to claim 16 wherein, said work table includes a throat plate disposed within a cavity defined by said work table and extending through said work surface, said throat plate defining said aperture in said work table, said throat plate being prevented from being properly disposed within said cavity when said lever is in said first position.

18. The machine tool according to claim 2 wherein, said cutting tool is biased against a face of said support plate.

19. The machine tool according to claim 2 wherein, said work table includes at least one adjustable stop, said adjustable stop including a cam rotatably secured to said work table, said cam being selectively locked to said work table in a plurality of positions to adjustably limit the pivoting of said support plate.

20. The machine tool according to claim 1, wherein the motor drives a arbor shaft, the cutting tool being drivingly connected to the arbor shaft, and the arbor shaft having multiple threads.

21. The machine tools according to claim 20, wherein the arbor shaft has a double thread.

22. A machine tool comprising:
a work table defining a work surface;
an arbor shaft having multiple threads;
a cutting tool rotatingly driven by the arbor shaft and movable with respect to said work table; and
a motor driving the arbor shaft.

23. The machine tools of claim 22, wherein the arbor shaft has a double thread.

24. The machine tool of claim 23, further comprising:
a mechanism for positioning said cutting tool relative to said working surface of said work table, said mechanism comprising:
a support plate pivotably secured to said work table, said cutting tool being mounted to said support plate to move between a first position where said cutting tool extends through an aperture in said work table and a second position where said cutting tool is positioned below said working surface;
a cutting tool angulating mechanism mounted to said support plate, said angulating mechanism being operable to pivot said support plate with respect to said work table such that said cutting tool angulates with respect to said working surface; and
a cutting tool elevating mechanism mounted to said support plate, said elevating mechanism being operable to move said cutting tool between said first and said second positions.
